(19) United States
(12) Patent Application Publication
(10) Pub. No.: US 2009/0226649 A1
(43) Pub. Date: Sep. 10, 2009

(54) INSERT MOLDED ARTICLE AND METHOD FOR MANUFACTURING THE SAME

(75) Inventors: Eiichiro GOTO, Aisai-shi (JP); Yoshihide Goto, Aisai-shi (JP); Hiroshige Nakabayahsi, Niigata-shi (JP)

Correspondence Address: BIRCH STEWART KOLASCH & BIRCH, PO BOX 747, FALLS CHURCH, VA, 22040-0747, US

(73) Assignees: Sanwa Screen Co., Ltd., Aisai-shi (JP); NAKABAYASHI INTERNATIONAL CONSULTING CO., LTD., Niigata-shi (JP)

(21) Appl. No.: 12/388,881

(22) Filed: Feb. 19, 2009

(30) Foreign Application Priority Data
Feb. 20, 2008 (JP) 2008-038621

(51) Int. Cl. B29C 45/14; B32B 27/00

(52) U.S. Cl. 428/34.9; 264/266

(57) ABSTRACT

An insert molded article is comprised of a thermoplastic resin molded article and a thermoplastic resin film-like body molded integrally with the molded article by insert molding. The film-like body is heated, during insert molding, to a temperature in which a secondary shrinkage factor thereof becomes equal to or larger than a shrinkage factor of the thermoplastic resin of the molded article. A manufacturing method of the insert molded article includes providing the thermoplastic resin film-like body to a concave portion of a female mold, forming a cavity of a shape capable of shaping the molded article on one surface of the film-like body, and injection molding the thermoplastic resin so that the film-like body is heated, inside the cavity, to a temperature in which the secondary shrinkage ration thereof becomes equal to or larger than the shrinkage ratio of the thermoplastic resin forming the molded article.

### BACKGROUND OF THE INVENTION

1. Field of the Invention

The present invention relates to an insert molded article to be used for home electric appliances and the like, and a method for manufacturing the same.

2. Description of the Related Art

Conventionally, there is known a molded article in which a thermoplastic resin molded body is coated with a thermoplastic resin film-like body, such as a display portion, a touch panel portion and the like of home electric appliances. As a method for manufacturing the molded article, there is known, for example, an insert molding method in which a thermoplastic resin forming the thermoplastic resin molded article is injected into a mold, in the condition where the thermoplastic resin film-like body is preliminary arranged inside the mold (for example, refer to Japanese Patent Laid-open Publication No. 2006-95937 (hereinafter Patent Document 1)).

Further, there is a molded article in which a window portion is provided by coating an opening portion of the thermoplastic resin molded article with the transparent thermoplastic resin film-like body, as the display portion and the touch panel portion of the home electric appliances. However, when manufacturing the molded article in which the thermoplastic resin molded article is coated by the thermoplastic resin film-like body with the insert molding method, there is a disadvantage that the thermoplastic resin film-like body generates deformation such as looseness or bulging with respect to the thermoplastic resin molded article at the region forming the window portion and the like, so that the quality of the external appearance of the product is impaired.

### SUMMARY OF THE INVENTION

An object of the present invention is to dissolve such disadvantage and therefore to provide an insert molded article in which a thermoplastic resin film-like body does not generate deformation such as looseness or bulging with respect to a thermoplastic resin molded article.

Further, another object of the present invention is to provide a method for manufacturing the insert molded article.

The present inventors and the like have conducted keen examination on the reason of the generation of deformation such as looseness or bulging of the thermoplastic resin film-like body with respect to the thermoplastic resin molded article, in the insert molded article in which the thermoplastic resin molded article is coated by the thermoplastic resin film-like body. As a result of the examination, the present inventors have found that the film-like body comprised of the thermoplastic resin generates a secondary shrinkage by being heated inside the mold, and that the deformation is generated from stress relaxation when the shrinkage factor of the thermoplastic resin molded article is larger than the secondary shrinkage factor of the thermoplastic resin film-like body.

In order to achieve the above-mentioned object, the present invention provides an insert molded article comprised of a thermoplastic resin molded article, and a thermoplastic resin film-like body molded integrally with the thermoplastic resin molded article by insert molding; wherein the thermoplastic resin film-like body, during insert molding, is heated to a temperature in a range in which a secondary shrinkage factor of the thermoplastic resin film-like body becomes equal to or larger than a shrinkage factor of the thermoplastic resin forming the thermoplastic resin molded article.

In the insert molded article of the present invention, the thermoplastic resin film-like body is heated during the insert molding, to a temperature in the range in which the secondary shrinkage factor of the thermoplastic resin film-like body becomes equal to or larger than the shrinkage factor of the thermoplastic resin forming the thermoplastic resin molded article. Therefore, the thermoplastic resin film-like body is capable of shrinking following the shrinking of the thermoplastic resin, so that the insert molded article without deformation such as looseness or bulging with respect to the thermoplastic resin may be obtained.

The insert molded article mentioned above may be manufactured advantageously with a manufacturing method comprising the steps of arranging the thermoplastic resin film-like body to a concave portion of a female mold, forming a cavity of a shape capable of shaping the thermoplastic resin molded article on one surface of the thermoplastic resin film-like body, by combining a male mold equipped with a convex portion to the concave portion of the female mold, and injection molding the thermoplastic resin so as to heat the thermoplastic resin film-like body, inside the cavity, to a temperature in the range in which a secondary shrinkage factor of the thermoplastic resin film-like body becomes equal to or larger than a shrinkage factor of the thermoplastic resin forming the thermoplastic resin molded article.

### BRIEF DESCRIPTION OF THE DRAWINGS

FIG. 1 is a perspective view indicating one constitutional example of an insert molded article of the present invention;

FIG. 2 is a cross-sectional view taken along line II-II in FIG. 1;

FIG. 3 is an explanatory cross-sectional view indicating the manufacturing method of the insert molded article shown in FIG. 1; and

FIG. 4 is an explanatory cross-sectional view indicating the manufacturing method of the insert molded article shown in FIG. 1.

### DETAILED DESCRIPTION OF THE PREFERRED EMBODIMENTS

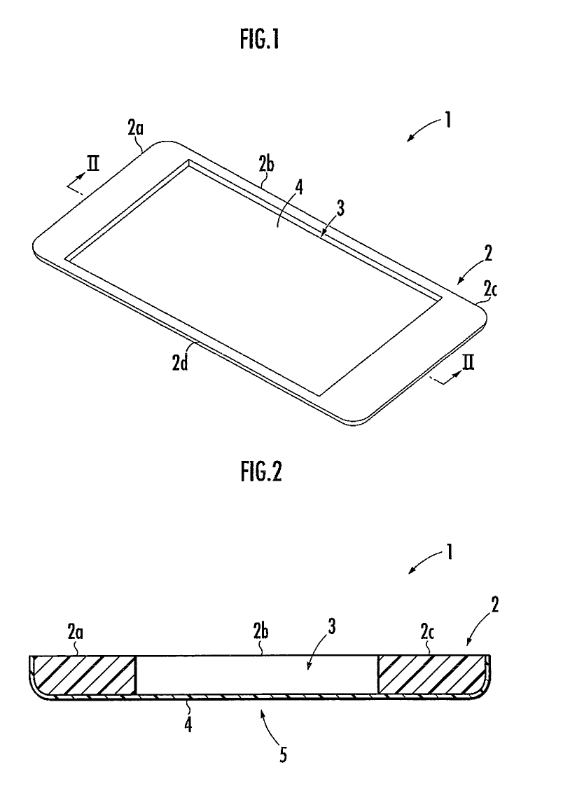

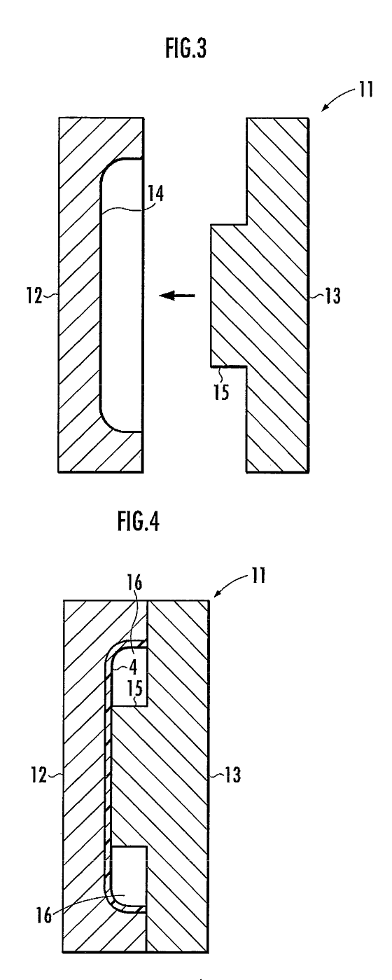

Next, an embodiment of the present invention will now be explained in detail below, with reference to the accompanying drawings. FIG. 1 is a perspective view indicating one constitutional example of an insert molded article of the present invention, FIG. 2 is a cross-sectional view taken along line II-II in FIG. 1, and FIG. 3 and FIG. 4 are explanatory cross-sectional views indicating the manufacturing method of the insert molded article shown in FIG. 1.

As shown in FIG. 1 and FIG. 2, an insert molded article 1 of the present embodiment is comprised of frame portions 2a, 2b, 2c, and 2d, a thermoplastic resin molded article 2 equipped with an opening portion 3 which is surrounded by the frame portions 2a, 2b, 2c, and 2d, and a transparent thermoplastic resin film-like body 4 which coats the entire thermoplastic resin molded article 2. In the insert molded article 1, a window portion 5 is formed at the region where the thermoplastic resin film-like body 4 coats the opening portion 3.

In the insert molded article 1 of the present embodiment, the thermoplastic resin molded article 2 is comprised of an acrylonitrile-butadiene-styrene copolymerized (ABS) resin, and the thermoplastic resin film-like body 4 is comprised of a polyethylene terephthalate (PET) resin. Here, the shrinkage factor of the ABS resin is about 0.45%, whereas the secondary shrinkage factor of the PET resin is generally about 0.03%. Therefore, when the thermoplastic resin molded article 2 comprised of the ABS resin and the thermoplastic resin film-like body 4 comprised of the PET resin are molded integrally by insert molding, there is a fear that deformation such as looseness, bulging and the like may be generated at the thermoplastic resin film-like body 4 comprised of the PET resin which forms the window portion 5, because the shrinkage of the thermoplastic resin molded article 2 comprised of the ABS resin is larger.

Therefore, in the insert molded article 1 of the present embodiment, the thermoplastic resin film-like body 4 comprised of the PET resin is heated, during insert molding, to a temperature of a range in which the secondary shrinkage ratio thereof becomes larger than the shrinkage ratio of the ABS resin.

Next, with reference to FIG. 3 and FIG. 4, the manufacturing method of the insert molded article 1 of the present embodiment will be explained.

As shown in FIG. 3, a mold 11 used in the manufacturing method of the present embodiment is equipped with a female mold 12 and a male mold 13. The female mold 12 is equipped with a concave portion 14 of a shape which meets the outer shape of the insert molded article 1, and a heating means, which is not shown. Further, the male mold 13 is equipped with a convex portion 15 which becomes a core portion forming the opening portion 3, and a runner, a gate, a heating means and the like, which are not shown.

In the manufacturing method of the present embodiment first as shown in FIG. 4, in the state where the thermoplastic resin film-like body 4 comprised of the PET resin is placed on the concave portion 14 of the female mold 12, the mold 11 is closed so as to combine the female mold 12 and the male mold 13. By doing so, a cavity 16 is formed by the concave portion 14 and the convex portion 15.

Next, the ABS resin is injected into the cavity 16 via the runner and the gate equipped to the male mold 13, which are not shown, so as to form the insert molded article 1. At this time, in the present embodiment, the ABS resin is injected in the state where the thermoplastic resin film-like body 4 comprised of the PET resin is heated inside the cavity 16 to a temperature in the range in which the secondary shrinkage factor of the PET resin film becomes larger than the shrinkage factor of the ABS resin.

The secondary shrinkage factor of the PET resin film is known to vary with temperature, and could be determined by conducting an experiment beforehand. Next, the shrinkage amount of the PET resin film having the length of 803.7 mm and the thickness of 0.188 mm being heated for 15 seconds at 80° C., 120° C., and 150° C., respectively, and then cooled to room temperature is measured, and the secondary shrinkage factor is calculated from the shrinkage amount. The result is shown in Table 1.

TABLE 1

| | 80° C. | 120° C. | 150° C. |
|---|---|---|---|
| Shrinkage amount (mm) n = 3 | 0.2 | 2.8 | 6.2 |
| | 0.3 | 2.9 | 6.1 |
| | 0.3 | 2.8 | 6.2 |
| Average shrinkage amount (mm) | 0.27 | 2.83 | 6.17 |
| Secondary shrinkage factor (%) | 0.03 | 0.35 | 0.77 |

From Table 1, if the secondary shrinkage factor of the PET resin film is approximated as being proportional to the temperature in the temperature range between 120 to 150° C., the secondary shrinkage factor of the PET resin film become 0.49% at 130° C., which is apparently larger than the shrinkage factor of the ABS resin which is 0.45%.

Therefore, in the present embodiment, the thermoplastic resin film-like body 4 comprised of the PET resin is heated inside the cavity 16 to 130° C. or more, by controlling the injecting condition of the ABS resin. Specifically, by using an injection molding machine of 80 tons with the cylinder temperature being set at 230° C., and by heating the female mold 12 and the male mold 13_by a heater or vapor, it is set so that the cavity 16 is heated to the temperature in the range of 120-140° C., and the convex portion 15 is heated to the temperature in the range of 80-100° C.

As a result, the insert molded article 1 equipped with the flat window portion 5 may be obtained, without generating looseness or bulging at the region forming the window portion 5 of the thermoplastic resin film-like body 4.

Here, in the present embodiment, the case where the thermoplastic resin molded article 2 is comprised of the ABS resin, and the thermoplastic resin film-like body 4 is comprised of the PET resin is being explained. However, the thermoplastic resin forming the thermoplastic resin molded article 2 and the thermoplastic resin film-like body 4 may be of other types.

Further, in the present embodiment, it is explained that the thermoplastic resin molded article 2 is equipped with the opening portion 3. However, it is also possible that the thermoplastic resin molded article 2 is not equipped with the opening portion 3, and the thermoplastic resin film-like body 4 coats the entire single surface of the thermoplastic resin molded article 2. In this case, the insert molded article 1 in which the thermoplastic resin film-like body 4 does not generate looseness or bulging with respect to the thermoplastic resin molded article 2 may be obtained, as is the same with the present embodiment.

Further, according to the manufacturing method of the insert molded article of the present embodiment, by heating during insert molding, the secondary shrinkage factor of the thermoplastic resin film-like body 4 may be adjusted so as to match the shape of the surface of the thermoplastic resin molded article 2 which is to be coated by the thermoplastic resin film-like body 4. As a result, even in the case where the surface of the thermoplastic resin molded article 2 which is coated by the thermoplastic resin film-like body 4 is a curved surface with the thermoplastic resin film-like body 4 being the inner circumferential surface, the insert molded article 1 in which the thermoplastic resin film-like body 4 does not generate looseness or bulging with respect to the curved surface may be obtained.

What is claimed is:

1. An insert molded article comprised of a thermoplastic resin molded article, and a thermoplastic resin film-like body molded integrally with the thermoplastic resin molded article by insert molding; wherein
the thermoplastic resin film-like body, during insert molding, is heated to a temperature in a range in which a secondary shrinkage factor of the thermoplastic resin film-like body becomes equal to or larger than a shrinkage factor of the thermoplastic resin forming the thermoplastic resin molded article.

2. A method for manufacturing an insert molded article comprised of a thermoplastic resin molded article, and a thermoplastic resin film-like body molded integrally with the thermoplastic resin molded article by insert molding, the method comprising the steps of:
arranging the thermoplastic resin film-like body to a concave portion of a female mold,
forming a cavity of a shape capable of shaping the thermoplastic resin molded article on one surface of the thermoplastic resin film-like body, by combining a male mold equipped with a convex portion to the concave portion of the female mold, and
injection molding the thermoplastic resin so as to heat the thermoplastic resin film-like body, inside the cavity, to a temperature in the range in which a secondary shrinkage factor of the thermoplastic resin film-like body becomes equal to or larger than a shrinkage factor of the thermoplastic resin forming the thermoplastic resin molded article.
